(19) United States
(12) Patent Application Publication
(10) Pub. No.: US 2015/0264721 A1
(43) Pub. Date: Sep. 17, 2015

(54) AUTOMATED PROGRAM SELECTION FOR LISTENING DEVICES

(71) Applicant: WOLFSON DYNAMIC HEARING PTY LTD, Richmond, Victoria (AU)

(72) Inventor: Anthony John Shilton, Richmond (AU)

(21) Appl. No.: 14/433,027

(22) PCT Filed: Oct. 4, 2013
(86) PCT No.: PCT/AU2013/001141

§ 371 Date: Apr. 1, 2015

Related U.S. Application Data
(60) Provisional application No. 61/710,239, filed on Oct. 5, 2012.

(51) Int. Cl. H04W 76/02; H04M 3/42; H04W 4/00

(52) U.S. Cl. CPC H04W 76/02; H04W 4/008; H04M 3/42391

(57) ABSTRACT

Automated control of a program of a listening device, such as a hearing aid. A communications link is established between a personal portable computing device, such as a smartphone, and the listening device. The smartphone obtains situational information pertaining to the user, such as GPS location, ambient light level, time of day, calendar information, or the like. The smartphone processes the situational information and selects a program. The selected program, or information identifying the selected program, is communicated to the listening device via the communications link.

### CROSS-REFERENCE TO RELATED APPLICATIONS

This application claims the benefit of U.S. Provisional Patent Application No. 61/710,239 filed 5 Oct. 2012, which is incorporated herein by reference.

### TECHNICAL FIELD

The present invention relates to listening devices, such as hearing aids and assistive listening devices (ALDs), which operate in accordance with a controllable sound processing program. In particular the invention relates to a system and method in which the program of the listening device is controlled or selected in an automated manner based on information from a personal computing device of the user.

### BACKGROUND OF THE INVENTION

Listening devices, such as hearing aids, personal sound amplifiers and other assistive listening devices are widely used to assist users who are hard of hearing. Typically, when fitting a hearing aid for a new user, a hearing professional programs the hearing aid using an external computer temporarily connected to the device. The hearing professional can adjust many of the device's audio signal processing parameters on an individual basis. When each parameter is optimised for that user, that particular set of parameter values is referred to as the “program”. Hearing aids can be programmed with multiple programs that can be invoked by the wearer in order to accommodate different listening environments. For example, a “home” program may be established for optimal performance in quiet environments, and another “music” program may be established for optimal performance when the user wishes to listen to music. The parameter values required for each program are stored within the device and can be selected by the user pressing buttons either on the device itself or on a remote control.

Some hearing aids change program in an automated manner in response to detected signal conditions, for example a “home” program may be loaded when the device detects a lower noise floor in the audio signal received by the device microphone.

For aesthetic and functional reasons there has been great emphasis on miniaturisation of hearing aids and ALD miniaturisation.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a method of automated control of a program of a listening device, the method comprising:
establishing a communications link between a personal portable computing device and the listening device;
the personal portable computing device obtaining situational information pertaining to the user;
the personal portable computing device processing the situational information and selecting a program; and
the personal portable computing device communicating the selected program, or information identifying the selected program, to the listening device via the communications link.

According to a second aspect the present invention provides a system for automated control of a program of a listening device of a user, the system comprising:
a personal portable computing device configured to obtain situational information pertaining to the user, and further configured to process the situational information and select a program; and
a listening device for processing audio signals for the user in accordance with the selected program;
wherein the personal portable computing device and listening device are configured to establish a communications link with each other, and the personal portable computing device is configured to communicate the selected program, or information identifying the selected program, to the listening device via the communications link.

Obtaining the situational information may in some embodiments comprise a sensor of the personal portable computing device sensing the situational information. For example the personal portable computing device may have a GPS receiver via which the personal portable computing device senses the location of the user, and based on the sensed location the personal portable computing device may select a program which should be used by the listening device. Additionally or alternatively the personal portable computing device may have a camera which may sense an average light level to ascertain whether the user is indoors or outdoors and determine therefrom which program should be selected. Additionally or alternatively the personal portable computing device may refer to an internal or external clock from which the personal portable computing device may determine for example when a “home” or “work” program should be selected.

Additionally or alternatively, obtaining the situational information may in some embodiments comprise the personal portable computing device retrieving situational information from a source external to the personal portable computing device and to the listening device. For example the personal portable computing device may retrieve situational information via a communications network such as the Internet. A mobile telephony connection strength indicator (e.g. a received signal strength indicator (RSSI)) may in some embodiments be used to alter the program, for example where a deterioration in voice quality may require changed processing of telephony audio by the listening device, effected via a changed program. Alternatively mobile telephony triangulation techniques may be used to determine an approximate location of the user to control program selection by the personal portable computing device.

In some embodiments of the invention, obtaining the situational information may additionally comprise passing a signal from a microphone of the listening device, and/or signal information from such a signal, to the personal portable computing device for use by the personal portable computing device in processing the situational information and selecting a program. Such embodiments may be particularly advantageous in providing the personal portable computing device with signal information from a known location (e.g. behind the ear), in contrast to information sensed by sensors of the portable device itself which may at times be occluded by being placed in the user's pocket or a bag, so that at such times the signal from the listening device microphone can be relied upon to maintain more suitable operation of program selection by the personal portable computing device.

Moreover, in embodiments in which obtaining the situational information comprises passing a signal from a microphone of the listening device, and/or signal information from such a signal, to the personal portable computing device, a feedback loop may be implemented by the personal portable computing device to optimise user perception of speaker output. In such embodiments, when audio is produced through speakers distal from the listening device such as on the personal portable computing device, the personal portable computing device may derive information from the listening device microphone signal and use it to update control settings of the speakers and/or the program of the listening device.

In some embodiments of the invention the personal portable computing device may update the selection of the program at suitable times, such as: at regular intervals and/or predefined times of day; in response to thresholding of the situational information; when prompted by the user; and/or in response to other inputs.

Controlling of the program of the listening device may comprise altering one or more parameters which define operation of the program. In such embodiments, the communication via the communications link may comprise new values for one or more parameters as determined by the personal portable computing device, to replace former program parameters controlling the listening device operation. Alternatively, the listening device and/or the personal computing device of the user may store a plurality of programs, from which one program may be selected for use at any given time based on the information from the personal computing device. In embodiments in which the listening device stores a plurality of programs, the communication via the communications link may comprise a program identifier, which may be used by the listening device to retrieve from its memory an alternative program associated with that identifier and commence using such program. In embodiments in which the personal portable computing device stores a plurality of programs, the communication via the communications link may comprise a complete copy of an alternative program selected by, and retrieved from a memory of, the personal portable computing device.

Alternatively the user's personal portable computing device may deliver program updates to a dedicated hearing aid device, such as a behind-the-ear or in-the-ear hearing aid processor, the dedicated hearing aid device processing the microphone signal to produce a processed signal in accordance with the current program as selected by the personal portable computing device.

In some embodiments, a binaural listening system may be controlled in accordance with the present invention, whereby a program of a left-side listening device and a program of a right-side listening device are each controlled in an automated manner by the personal portable computing device based on the situational information. The binaural listening system may in some embodiments be effected in the manner set out in U.S. provisional patent application No. 61/710,248 filed simultaneously with the present application and entitled “Binaural hearing system and method”.

According to a further aspect the present invention provides a computing device configured to carry out the method of the first aspect.

A non-transitory computer readable medium for automated control of a program of a listening device, comprising instructions which, when executed by one or more processors, causes performance of the following:
establishing a communications link between a personal portable computing device and the listening device;
the personal portable computing device obtaining situational information pertaining to the user;
the personal portable computing device processing the situational information and selecting a program; and
the personal portable computing device communicating the selected program, or information identifying the selected program, to the listening device via the communications link.

### BRIEF DESCRIPTION OF THE DRAWINGS

An example of the invention will now be described with reference to the accompanying drawings, in which:

FIG. 1 illustrates a system for automated control of a program of a listening device in accordance with one embodiment of the invention; and

FIG. 2 is a flowchart of a method for automated control of a program of a listening device, as carried out by the system of FIG. 1.

### DESCRIPTION OF PREFERRED EMBODIMENTS

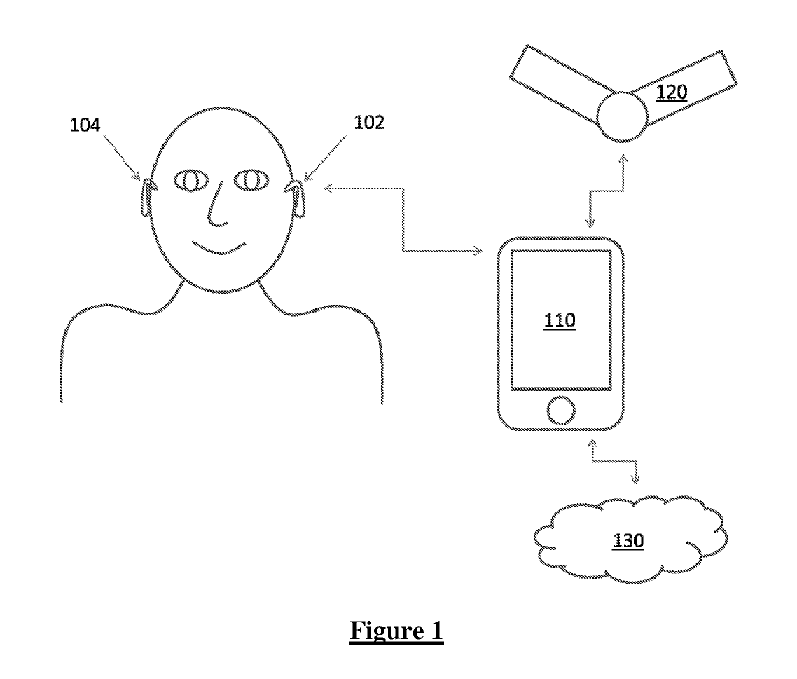

FIG. 1 illustrates a system for automated control of a program of a listening device (102, 104) in accordance with one embodiment of the invention. A personal portable computing device 110 of the user uses location and connection information to select the correct hearing aid settings, i.e. the respective programs, of the devices 102, 104. Device 110 is a smartphone and uses GPS system 120 to determine the user's location. The device 110 executes an application which takes such information and, when so indicated by the location information, selects a respective new hearing program to be executed by each of the hearing aids 102, 104.

The phone 110 has GPS, connectivity to internet 130 and/or other data or telephony networks via Bluetooth, WiFi, NFC, WCDMA and the like, a camera, a clock, a calendar, an accelerometer, and a gyroscope. The phone 110 also knows if the user is on a call, listening to music stored in device 110, watching a video, reading an e-book, waiting for an appointment stored in the e-calendar of the device, and so on. The phone 110 is thus an advanced computing device which carries or can retrieve a substantial amount of situational information about the surrounding environment and the user's situation. This information can be used to make well informed decisions about when to switch the hearing aids 102, 104 to the best program to suit the situation.

The present embodiment of the invention recognises that hearing aids have only microphones and have no time clock, no GPS, no network connectivity nor many other smartphone functions.

Device 110 is a smart phone, but in other embodiments could be a tablet computer, e-reader, or the like. The selection of the listening program may be performed by an app executed by a smart phone.

Device 110 also retrieves signal information from the microphones of the hearing aids 102, 104. In this way, even when the device 110 is occluded such as by being placed in the user's pocket or a bag, audio input from a reliable location behind the user's ear can be obtained for the device 110 to continue to determine a suitable program based on audio inputs.

The device 110 also has a speakerphone mode of operation. To optimise the user's perception of sound from the speakerphone, the device 110 retrieves the microphone signals from the hearing aids 102, 104 during audio output from the speakerphone. For example the audio output from the speakerphone of the device 110 may be a telephone call placed on loudspeaker, audio accompanying a video clip playback, music playback, or other audio output. Device 110 analyses the hearing aid signals and uses this information to control both (a) the settings of the signal processing which produces the audio output from the speakerphone of the device 110, and (b) the program settings to be applied by the hearing aids 102, 104 when processing the acoustic output from the speakerphone.

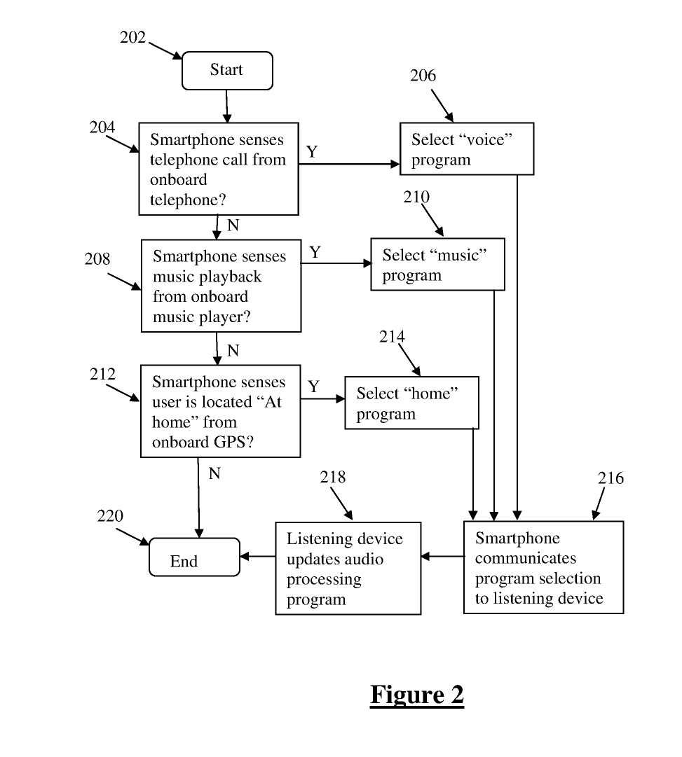

FIG. 2 is a flowchart of a method for automated control of a program of a listening device, as carried out by the system of FIG. 1. The method starts at 202 at any suitable time, such as at regular intervals and/or predefined times of day; in response to thresholding of the situational information; when prompted by the user; and/or in response to other inputs. In turn, the smartphone 110 senses whether the user is currently conducting or initiating a telephone call using the phone 110, and if so at 206 the smartphone selects a “voice” program which has been predefined to optimise audio processing for the user in response to voice audio.

If at 204 no phone call is underway, the smartphone at 208 senses whether the user is playing back music from an onboard music player of the smartphone. If so, at 210 the smartphone selects a “music” program which has been predefined to optimise audio processing for the user in response to musical audio.

If at 208 music playback is not occurring, the smartphone 110 at 212 senses whether the onboard GPS indicates that a current location of the user is “at home”, as may be defined in any suitable manner. If so, at 214 the smartphone selects a “home” program which has been predefined to optimise audio processing for the user when in a quiet indoor environment.

Following a program selection at any of 206, 210 or 214, at 216 the smartphone 110 communicates that particular program selection to the user's listening device 102 and/or 104 via the communications link, and at 218 the respective listening device updates its audio processing program accordingly. The process ends at 220 until a subsequent time at which the process is to be repeated.

It will be appreciated by persons skilled in the art that numerous variations and/or modifications may be made to the invention as shown in the specific embodiments without departing from the spirit or scope of the invention as broadly described. For example, the process of FIG. 2 may in alternative embodiments include additional sensing steps, such as by reference to ambient noise sensed by one or more microphones, by reference to other predefined user locations as sensed by the GPS, by reference to light level sensed by a camera, by reference to time as indicated by a clock, by reference to RSSI, or the like, each of which may lead to selection of a corresponding program. Moreover, situational information may be derived from more than one source and may be used to suitably define a program selection, such as in a combinatorial or hierarchical/prioritised treatment of the plurality of sources of situational information. The present embodiments are, therefore, to be considered in all respects as illustrative and not restrictive.

1. A method of automated control of a program of a listening device, the method comprising:
establishing a communications link between a personal portable computing device and the listening device;
the personal portable computing device obtaining situational information pertaining to the user;
the personal portable computing device processing the situational information and selecting a program; and
the personal portable computing device communicating the selected program, or information identifying the selected program, to the listening device via the communications link.

2. The method of claim 1 wherein obtaining the situational information involves a sensor of the personal portable computing device sensing the situational information.

3. The method of claim 2 wherein a GPS receiver of the personal portable computing device senses a location of the user, and wherein based on the sensed location the personal portable computing device selects a program which should be used by the listening device.

4. The method of claim 3 wherein a camera of the personal portable computing device senses an average light level and on the basis of whether the personal portable computing device ascertains that the user is indoors or outdoors, a program is selected.

5. The method of claim 4 wherein the personal portable computing device refers to a clock, from which the personal portable computing device determines a program to be selected.

6. The method of claim 5 wherein obtaining the situational information involves the personal portable computing device retrieving situational information from a source which is separate to both the personal portable computing device and the listening device.

7. The method of claim 6 wherein the source of situational information is accessed via the Internet.

8. The method of claim 7 wherein the situational information comprises the output of a received signal strength indicator.

9. The method of claim 8 wherein the situational information comprises a location of the user as determined by mobile telephony triangulation.

10. The method of claim 9 wherein the situational information comprises audio data derived from a microphone of the listening device.

11. The method of claim 10 further comprising the personal portable computing device optimising user perception of speaker output by refining speaker signal processing based on the audio data derived from the microphone of the listening device.

12. The method of claim 11 wherein the controlling of the program of the listening device comprises altering one or more parameters which define operation of the program.

13. The method of claim 11 wherein the controlling of the program of the listening device comprises selection and retrieval from memory of one of a plurality of predefined programs for use by the listening device.

14. The method of claim 13 wherein the memory is a memory of the listening device, and the program is identified by the personal portable computing device via the communications link.

15. The method of claim 13 wherein the memory is a memory of the personal portable computing device, and wherein the program is communicated from the personal portable computing device via the communications link.

16. A system for automated control of a program of a listening device of a user, the system comprising:
a personal portable computing device configured to obtain situational information pertaining to the user, and further configured to process the situational information and select a program; and
a listening device for processing audio signals for the user in accordance with the selected program;
wherein the personal portable computing device and listening device are configured to establish a communications link with each other, and the personal portable computing device is configured to communicate the selected program, or information identifying the selected program, to the listening device via the communications link.

17. The system of claim 16 wherein the listening device is a hearing aid.

18. The system of claim 16 wherein the listening device is a binaural listening system.

19. The system of claim 16 wherein the personal portable computing device is one of: a smartphone, a tablet device, and an e-reader.

20. A non-transitory computer readable medium for automated control of a program of a listening device, comprising instructions which, when executed by one or more processors, causes performance of the following:
establishing a communications link between a personal portable computing device and the listening device;
the personal portable computing device obtaining situational information pertaining to the user;
the personal portable computing device processing the situational information and selecting a program; and
the personal portable computing device communicating the selected program, or information identifying the selected program, to the listening device via the communications link.
